(19) United States
(12) Patent Application Publication
(10) Pub. No.: US 2019/0134540 A1
(43) Pub. Date: May 9, 2019

(54) FLOW SEPARATION SYSTEM IN MULTIFILTER UNITS

(71) Applicant: Salvador ROS ROCA, Roldan (ES)

(72) Inventor: Salvador ROS ROCA, Roldan (ES)

(21) Appl. No.: 15/888,206

(22) Filed: Feb. 5, 2018

(30) Foreign Application Priority Data
Nov. 7, 2017 (ES) P-201700761

(51) Int. Cl. B01D 29/33; B01D 29/52

(52) U.S. Cl. CPC B01D 29/33; B01D 2201/313; B01D 29/52

(57) ABSTRACT

FLOW SEPARATOR SYSTEM IN MULTIFILTER UNITS composed of a number of bodies called flow separators, each of which is fitted around a filter and where each separator body comprises a support structure formed by a base, a number of rods and a cap, such that, along the said support structure, a flexible screen is fitted, with a helicoidal configuration, integrated with the movement of the support structure such that each flow separator body retains the dirt particles before they reach each filter, controlling the flow to be purified by each filter, redirecting the flows and preventing the flows between the different filters that make up the system from being mixed together.

Flow separation system in multifilter units.

### OBJECT OF THE INVENTION

The invention is designed to protect each of the internal filters in a multifilter unit, intended for the purification of liquids, preventing the filters from becoming clogged with dirt or solid particles during the purification or cleaning of the liquid; accordingly, the flow separation system of the invention is composed of a number of bodies called flow separators, each fitted around a filter and which, with a specific configuration, successfully retain the dirt particles before they reach the filter, controlling the flow to be purified by each filter and redirecting the flows, preventing the flows between the different filters that make up the system from being mixed together.

The flow separation system in multifilter units is composed of a number of flow separator bodies, each comprising a support structure made up of a specific base, rods and a cap; around which a helicoidal screen is fitted.

The field of application of the invention falls in the manufacture of filtering equipment for piping installations for all kinds of fluids, such as water, dairy products, agri-food, pharmaceuticals, desalination and similar; more specifically, it is for the irrigation industry.

### BACKGROUND OF THE INVENTION

The field dedicated to water treatment and cleaning machinery, such as multifilter units, has evolved rapidly in recent times, mainly due to the development of its use in irrigation applications.

This evolution seeks to achieve better use of water resources, especially in regions where there is a shortage of natural water, where it has also been necessary to develop advanced irrigation techniques, such as drip irrigation and micro-sprinklers for highly efficient water use. Accordingly, it is known that water generally used for irrigation is of poor quality and is not for human consumption. Furthermore, the water used often contains impurities which, although they are not harmful for traditional irrigation techniques, can pose a serious problem in drip irrigation and micro-sprinkler systems.

In view of the above, it is currently necessary to fit filters to, as far as possible, prevent impurities in the water flow from reaching the aforementioned drip irrigation and micro-sprinkler installations. In the state of the art, we highlight the so-called ring filters, e.g. the one presented in document ES1055543U, which divulges a filter element composed of a number of grooved plastic rings through which the filtering is performed. These ring filters make it possible to deal with the problem of impurities; however, another problem arises from the necessary cleaning and maintenance operations associated with their operation to eliminate the impurities that are accumulated.

In connection with the foregoing, it is important to note that a number of self-cleaning filters have long been known and used in which two coaxial chambers in a substantially cylindrical housing, one perimetral and the other axial, connected to each other through a number of filter discs fitted on their grooved faces, such that when the said discs are overlapped, the said grooves are converted into small-calibre ducts, which is what give these filters the filtering effect. The problem of these filters lies in their reduced self-cleaning capacity for large installations and greater flow demands.

In order to solve the problem of cleaning the filters, other types of solutions are known, e.g. the one divulged in document ES1059225U, which presents a solution in which a filter made up of a number of filter rings or discs with tubes passing through the support of the rings make it possible to modify the water flow to improve the cleaning of the unit. This type of solution has the disadvantage of presenting inflexible solutions for facilities with low flow demands in which the filters are not subjected to high pressure.

Therefore, for installations with greater demands and in an attempt to make equipment as compact as possible and economise installations, the tendency began to use multifilters consisting of the technologies we have just mentioned, i.e. filters generally with circular and concentric rings, as divulged in document ES1062189U, or solutions consisting of structural reconfigurations of the unit, as divulged in document ES2319335, and to adapt conventional or ring filters internally; however, the disadvantage is known in the sector where these types of rings on their own accumulate a lot of dirt over time and, together with the generation of unwanted water flows, this prevents the correct cleaning of the different filters inside the unit.

In view of the prior art, there is no known device or system that separates flows in a multifilter unit or in which the flow rate is controlled inside each filter separately in the same unit.

For this reason, the flow separation system in multifilter units that is the object of this invention goes one step further in the field of filtration equipment since this document describes a solution based on flexible, elastic physical separators that can be compressed or expanded depending on the pressure and current of the liquid inside each filter, which allows the system to adapt to the conditions of the liquid; and in which each filter is covered separately so that the filters do not interact with each other, thus obtaining a perfect seal inside the element and eliminating unwanted flows. This improves the cleaning system in general, minimises maintenance work and optimises and extends the service life, unlike what is currently known in irrigation or similar installations.

The following is a detailed description of the invention that supplements the general ideas introduced here.

### DESCRIPTION OF THE INVENTION

The flow separation system in multifilter units is composed of a number of bodies called flow separators. Each flow separator is located around each of the filters that make up the multifilter unit in the system, protecting them from clogging, regulating the purification flow rate so that they do not get blocked and separating the flows between the different filters, which improves cleaning, as described later.

Each of these flow separator bodies or elements preferably has a hollow tubular geometry and their dimensions are such that when they contain a filter or filtration element, there is space on the perimeters between the walls of both elements.

The flow separator body is formed by a support structure of preferably rigid material and a screen with a flexible helicoidal configuration, supported by the structure and integrated in the movements thereof.

The support structure consists of a base, rods and a cap. The said base is flat and unique in that its central axis has an axial recess of a dimension or diameter sufficient for inserting and fitting a filter.

Furthermore, the said base also has a number of small recesses set around the recess described above to position or insert rods. At one end, the rods are attached to the base through the above-mentioned recesses and, at the opposite end, they are attached to a so-called cap, which has the same dimensions at its perimeter as the base, is flat and compact and is positioned parallel to the said base, thus remaining opposite to it. According to the results obtained in tests, the most appropriate number of recesses and rods is five.

There is a screen fixed around the rods that make up the support structure, more specifically between the rods, the base and the cap by way of a cover. The screen is composed of a flexible, malleable material and has a spiral or helicoidal configuration. The spiral screen has two types of sections in its configuration as a whole, defined as a section of circular lines and a section of radial lines.

Both sections are superimposed on the entire spiral, which is shaped as a single piece, preferably obtained by extrusion. Thus, when the flow separator body assembly is stopped or in standby position, protecting each of the filters of the multifilter unit that is the object of this invention, the spiral is fully open and when the flow separator body is receiving water or in working position, the spiral is closed to control the inlet flow.

Having defined in detail the body or flow separator element that forms part of the system of the invention, we will now describe the system as a whole.

As already mentioned, each filter in the flow separation system in multifilter units that is the object of this invention is contained in the previously defined flow separator body. When the system as a whole is in standby position, i.e. the system does not contain liquid, the entire screen spiral that makes up the separator body is ringed and the flow separator body is contracted around the filter.

As a result of the two types of sections that make up the helicoidal element, along the entire surface of the element there are interstices or small spaces forming channels to allow the gradual entry of the liquid inside. Accordingly, the liquid to be treated must first enter the multifilter. When the multifilter as a whole is being filled, all the walls of the flow separator bodies that make up the system are subjected to compressive surface pressure. Then, through the interstices formed by the helicoidal element, the purified liquid enters gradually, regulating the flow inside the separator body, where the filter is located. As the liquid is filtered through the so-called separator body, the pressure inside the said body increases as a result of the flexibility of the helicoidal element and the rods and the flow separator body as a whole is stretched longitudinally. This means that the helicoidal element stretched with the longitudinal movement of the said rods acts at all times as a regulator, in this case preventing more flow inside the separator body than possible due to its tubular volume. Here, it could be said that the flow separator element or body is in working position with the spiral or helicoidal element open.

Furthermore, the system of the invention also contains as many flow separator elements as filters inside the multifilter unit. This is why each filter purifies optimally, since there is no exchange of flows between the different filters and each one is protected by a flow separator element acting as the first part that retains unwanted dirt or solid particles and also preventing the formation of non-substantial currents, separating the flows and preventing liquids from other filters from mixing together, thus improving the cleaning, maintenance and performance of the system as a whole.

In order to complete this description and to ensure a better understanding of the characteristics of the invention, a set of drawings is attached as an integral part thereof showing the following for illustration purposes and not limited thereto.

In the drawings:

FIG. 1 is a schematic representation of a flow separator system in a multifilter unit, where the inlet of the dirty liquid into the unit is on the side and the outlet of the clean liquid is at the bottom.

FIG. 2 is a schematic representation of the elements that make up a flow separator body.

FIG. 3 is a schematic representation of a longitudinal section of a flow separator body at the beginning of the liquid filtration, when the helicoidal element is compressed and is regulating the flow rate.

FIG. 4 is a schematic representation of a longitudinal section of a flow separator body in working position during the cleaning of the filter, when the helicoidal element is fully open around the filter, correctly redirecting the flows.

FIG. 5 is a view of the section of the helicoidal screen shown in the previous figure.

### DESCRIPTION OF THE DRAWINGS

As shown in FIG. 1, the flow separator system for multifilter units that is the object of the invention is composed of a number of bodies called flow separators (1). Each flow separator body or element (1) is set around each of the filters (2) that make up the multifilter unit (3) of the system, protecting them from clogging when the liquid enters since each of the said separator bodies (1) regulates the purification flow in each filter (2) and separates the flows between them such that the clean water flowing out of the multifilter unit (3) is evacuated free of impurities, as shown schematically in the said FIG. 1.

FIGS. 3 and 4 show that each flow separator body (1) preferably has a hollow tubular geometry and their dimensions are such that when they contain a filter (2), there is space on the perimeters between the walls of both elements.

As shown in FIG. 2, the flow separator body (1) is formed by a support structure (11) of preferably rigid material and a screen (12) with a flexible helicoidal configuration, supported by the structure and integrated in the movements thereof. It should be noted that this figure shows the screen (12) schematically so as to clearly indicate the position of the spiral inside the unit.

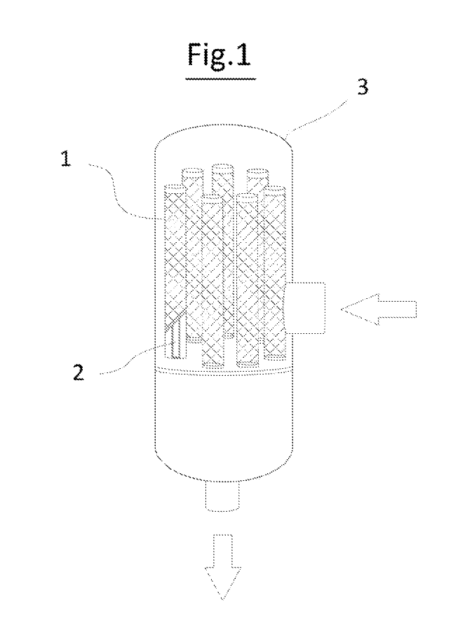

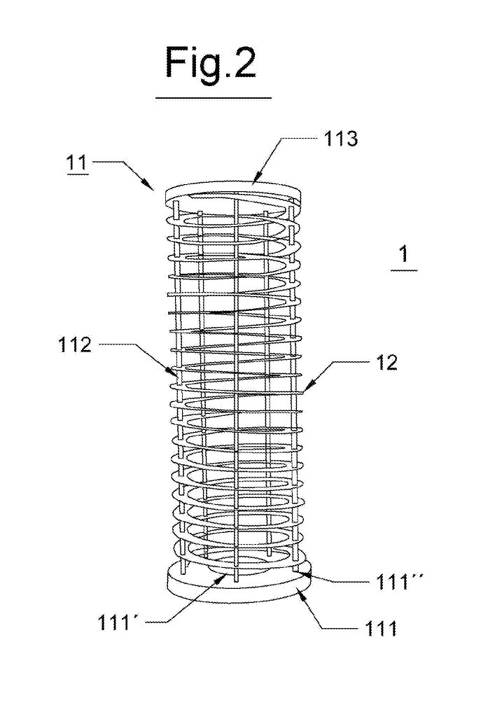

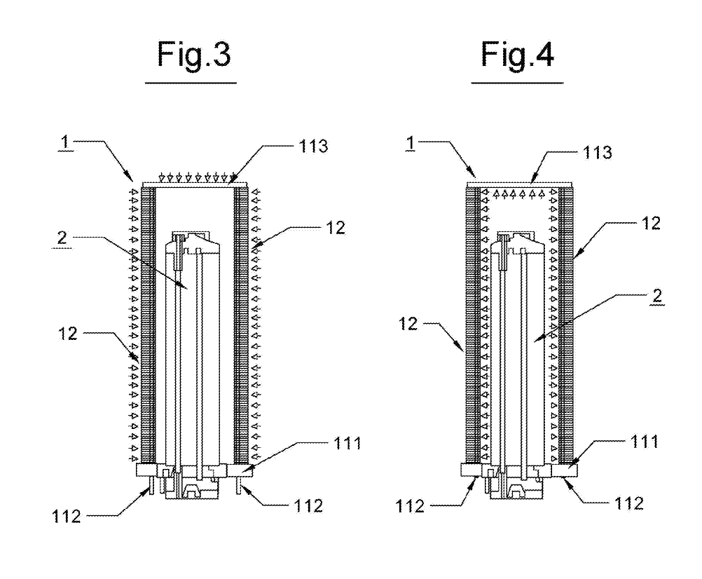

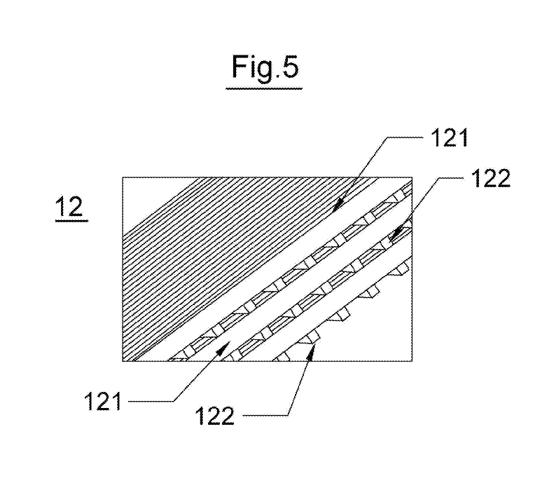

The support structure (11) consists of a base (111), rods (112) and a cap (113). The said base (111) is flat and unique in that its central axis has an axial recess (111′) of a dimension or diameter sufficient for inserting and fitting a filter (2), as shown in FIGS. 3 and 4.

The said base (111) also has a number of small recesses (111″) set around the recess described above for positioning or inserting rods (112). As shown in FIG. 2, at one end, the rods (112) are attached to the base (111) through the above-mentioned recesses and, at the opposite end, they are attached to a so-called cap (113), which has the same dimensions at its perimeter as the base (111), is flat and compact and is positioned parallel to the said base (111), thus remaining opposite to it. According to the results obtained in tests, the most appropriate number of recesses (111″) in the base (111) and rods (112) is five, as shown in FIG. 2.

FIGS. 3 and 4 show that, set along the rods (112) that make up the support structure (11), more specifically from the base (111) to its cap (113) through the rods (112) by way of a cover, there is a screen (12). The screen (12) is composed of a flexible, malleable material and has a spiral or helicoidal configuration. (12) The spiral screen has two types of sections in its configuration as a whole, defined as a section of circular lines (121) and a section of radial lines (122), shown in FIG. 5.

Both sections are superimposed on the entire spiral of the screen (12), which is shaped as a single piece, preferably obtained by extrusion. Thus, as shown in FIG. 3, when the flow separator body assembly (1) is stopped or in standby position protecting each of the filters (2) of the multifilter unit that is the object of this invention, the spiral is fully open; and, as shown in FIG. 4, when the flow separator body (1) is in cleaning position, the spiral is open.

Having defined in detail the flow separator body (1) that forms part of the system of the invention, we will now describe the system as a whole.

As already mentioned, in the flow separation system in multifilter units that is the object of this invention, each filter (2) in the multifilter unit (3) is contained in the previously defined flow separator body (1). When the system as a whole is in standby position, i.e. the system does not contain liquid, the spiral of the screen (12) that makes up the flow separator body (1) is ringed and the separator flow body (3) is contracted around the filter (2). Schematic representation of FIG. 3.

As a result of the two types of sections (121 and 122) that make up the screen (12), along the entire surface of the helicoidal element there are interstices or small spaces forming channels to allow the gradual entry of the liquid inside. Accordingly, the liquid to be treated must first enter the multifilter. When the multifilter (3) as a whole is being filled, all the walls of the flow separator bodies (1) that make up the system are subjected to compressive surface pressure (FIG. 3). Then, through the interstices formed by the screen (12), the purified liquid enters gradually, regulating the flow inside the separator body (1), where the filter is located (2). As the liquid is filtered through the so-called flow separator body (1), the pressure in said element is increased, as a consequence of the flexibility of the helicoidal screen (12), together with the rods (112), and the separator body (1) as a whole stretches longitudinally (FIG. 4). This means that the flexible helicoidal screen (12) stretches with the longitudinal movement of the said rods (112), acting at all times as a regulator, in this case preventing more flow inside the flow separator body (1) than possible due to its tubular volume. At this point the separator body (1) is in working position with the spiral of the screen (12) closed.

Having sufficiently described the nature of the invention above, bearing in mind that the terms used in this specification should be taken in a broad and non-limiting sense, and how to put it into practice.

1. FLOW SEPARATION SYSTEM IN MULTIFILTER UNITS designed to filter liquids and prevent the filters from clogging up with dirt or solid particles during purification or cleaning of the liquid to be treated and redirect the flows during the cleaning of the filters, characterised in that each filter (2) has a flow separator body (1) covering it in such a way that each flow separator body (1) comprises:
a support structure (11) formed by a base (111), which has a central axis with an axial recess (111′) and a number of small recesses (111″) set around the recess (111′) and which also pass through the base (111); rods (112), which at one end are inserted through the small recesses (111′), as mentioned above, and at the opposite end are fixed to a compact cap (113), with a perimeter of the same dimensions as the base (111) and positioned parallel to the said base (111), whereby the cap (113) and the base (111) are positioned opposite each other; and
a screen (12) with a flexible helicoidal configuration, fixed to the support structure (11) along its rods (112) from its base (111) to its cap (113), integrated with the movement of the support structure (11) and gradually regulating the entry of the liquid into the flow separator body (1).

2. FLOW SEPARATOR SYSTEM IN MULTIFILTER UNITS according to claim 1, CHARACTERISED in that the screen (12) is constituted by a single piece with a section of circular lines (121) and a section of superimposed radial lines (122).

3. FLOW SEPARATOR SYSTEM IN MULTIFILTER UNITS according to claim 1, CHARACTERISED in that there are interstices or small spaces in the form of a channel along the entire surface of the screen (12).

4. FLOW SEPARATOR SYSTEM IN MULTIFILTER UNITS according to claim 2, CHARACTERISED in that there are interstices or small spaces in the form of a channel along the entire surface of the screen (12).
